(19) United States
(12) Patent Application Publication
(10) Pub. No.: US 2011/0235317 A1
(43) Pub. Date: Sep. 29, 2011

(54) LIGHTING DEVICE WITH THROW FORWARD REFLECTOR

(75) Inventors: Neal R. Verfuerth, Plymouth, WI (US); Kenneth J. Wetenkamp, Plymouth, WI (US)

(73) Assignee: Orion Energy Systems, Inc.

(21) Appl. No.: 12/748,318

(22) Filed: Mar. 26, 2010

(51) Int. Cl. F21V 7/00

(52) U.S. Cl. 362/217.05; 362/296.01; 362/341; 362/217.09

(57) ABSTRACT

A lighting device with a throw forward reflector includes a body, at least one light source coupled to the body, and a reflector with an asymmetric cross sectional geometry coupled to the body and at least partially about the light source to project light from the light source at an angle that is non-perpendicular to a plane of the body. A throw forward reflector includes an elongated reflector body formed from a sheet of material and has an asymmetric cross sectional profile, the profile comprising a compound radius having a first curved segment defined by a first radius and a second curved segment defined by a second radius that is greater than the first radius, and a crease extending at least partially along the length of the reflector body and defining an interface between the first curved segment and the second curved segment.

### FIELD

The field of the disclosure relates generally to lighting devices. More specifically, the disclosure relates to a fluorescent lighting device with a reflector having a geometry configured to project light downward and outward. More particularly, the disclosure relates to a fluorescent lighting device with one or more elongated and asymmetrically shaped reflectors configured to project light in a downward and forward direction (i.e. “throw forward”).

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Lighting devices such as light fixtures for interior applications (e.g. overhead fixtures in a building etc.) and exterior applications (e.g. parking lot light fixtures, street light fixtures, etc.) are typically provided as generally planar devices having reflectors that direct light from a light source (e.g. high intensity discharge (HID) bulb, high intensity fluorescent (HIF) bulb, etc.) in a direction that is usually perpendicular to the plane of the lighting device. Such reflectors are usually symmetric or substantially symmetric and the plane of the lighting device is usually arranged horizontally (e.g. in ceilings, etc.) so that the light from the light source is projected downwardly to illuminate a desired area. Although the light projected downwardly by such known reflectors also tends to migrate laterally to some degree, the amount of light projected laterally is often insufficient to illuminate such lateral areas. In such cases, an additional lighting device is often provided over such lateral areas, or the lighting device may be angled (e.g. tipped, etc.) to project light toward such lateral areas. However, in some cases it may not be practical or cost effective to install additional lighting fixture(s) over such lateral areas. Also, it may not be practical to angle such lighting fixtures upward, because for interior applications the lighting devices may need to fit within the plane of a ceiling, and for external applications, angling such lighting fixtures upward may result in increased wind loading on the fixture and/or may not provide “full cutoff” or be “dark-sky” compliant (i.e. cause little or no light to be cast upwardly above a horizontal plane).

Accordingly, it would be desirable to provide a lighting device having a generally planar profile that may be installed in a generally horizontal configuration, and having a reflector configured to throw (e.g. cast, project, etc.) light forward (i.e. at an angle that is non-perpendicular to the plane of the lighting device) to permit illumination of lateral areas without having to tip-up the lighting device or install a lighting device directly over the lateral area.

### SUMMARY

In an exemplary embodiment, a lighting device with a throw forward reflector includes a lighting device body, at least one light source coupled to the lighting device body, and an elongated reflector having an asymmetric cross sectional geometry coupled to the lighting device body and disposed at least partially about the light source to project light from the light source at an angle that is non-perpendicular to a plane of the lighting device body.

In another exemplary embodiment, a throw forward reflector includes an elongated reflector body formed from a sheet of material and has an asymmetric cross sectional profile, the profile comprising a compound radius having a first curved segment defined by a first radius and a second curved segment defined by a second radius that is greater than the first radius, and a crease extending at least partially along the length of the reflector body and defining an interface between the first curved segment and the second curved segment.

Other principal features and advantages of the various embodiments of invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, wherein like numerals denote like elements.

FIG. 1 depicts a schematic representation of a perspective view of an underside of a lighting device having elongated and asymmetrically shaped reflectors in accordance with an exemplary embodiment.

FIG. 2 depicts a schematic representation of a cross sectional view of the lighting device of FIG. 1 in accordance with an exemplary embodiment.

FIG. 3 depicts a schematic representation of a detailed cross sectional view of the elongated and asymmetrically shaped reflectors of the lighting device of FIG. 1 in accordance with an exemplary embodiment.

FIG. 4A depicts a schematic representation of a top view of a sheet of material to be formed into an elongated and asymmetrically shaped reflector of the lighting device of FIG. 1 in accordance with an exemplary embodiment.

FIG. 4B depicts a schematic representation of a cross sectional view of the sheet of material of FIG. 4A after a first forming operation, in accordance with an exemplary embodiment.

FIG. 4C depicts a schematic representation of a cross sectional view of the sheet of material of FIG. 4B after a second forming operation, in accordance with an exemplary embodiment.

FIG. 4D depicts a schematic representation of a cross sectional view of the sheet of material of FIG. 4C after a third forming operation to provide the elongated and asymmetrically shaped reflector of the lighting device of FIG. 1, in accordance with an exemplary embodiment.

### DETAILED DESCRIPTION

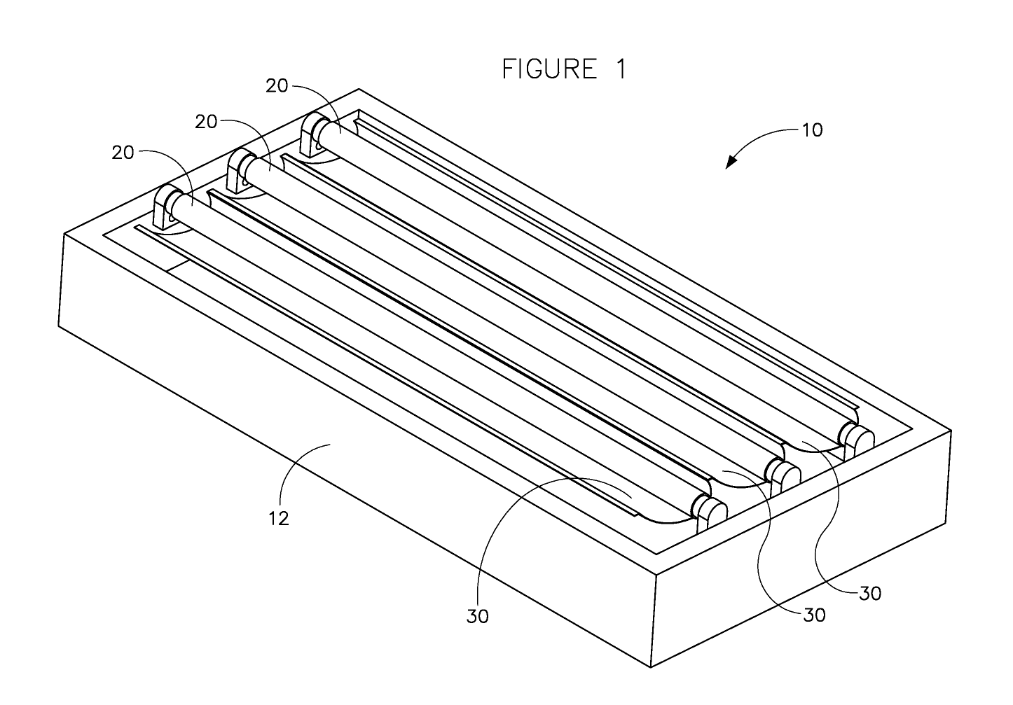

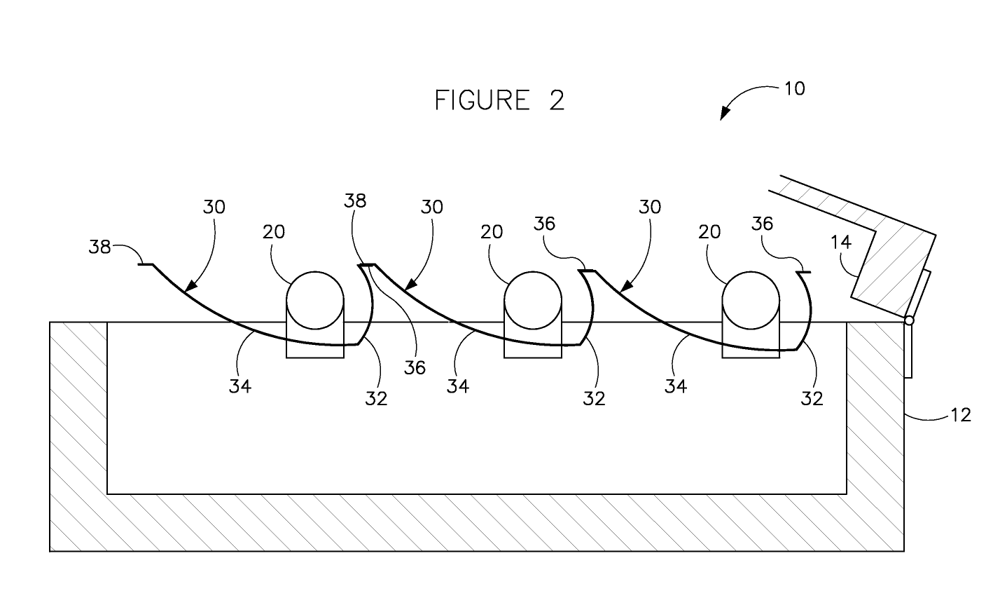

Referring to FIGS. 1 and 2, a lighting device 10 (e.g. fixture, appliance, etc.) having a generally planar or rectangular shape with a body 12 and a cover 14 is shown according to an exemplary embodiment to include one or more light sources 20 (shown for example as three (3) elongated high intensity fluorescent light bulbs), and an elongated reflector 30 having an asymmetric cross sectional geometry (e.g. profile, shape, formation, etc.) configured to cast light in a forward direction (i.e. at a non-perpendicular angle with respect to the plane of the lighting device). Reflector 30 is shown and described by way of example as a single reflector associated with a single light source, that is, one reflector for each light source where adjacent edges or flanges of the reflectors may overlap and may be secured to one another. However, according to alternative embodiments, a single reflector may be provided having a suitable number of reflective geometries that correspond to the number of light source(s) provided in the lighting device. Lighting device 10 is shown schematically and by way of example as a “closed” lighting device intended for use in exterior (e.g. outdoor) applications, such as street lights, parking lot lights, high-moisture locations, etc. and includes a cover 14 that encloses the light sources and reflector, and may be sealed to the body 12 of the lighting device. According to other embodiments, lighting device 10 may be provided without a cover and intended for use in interior (e.g. indoor) applications such as ceiling lighting, high-bay lighting, low-bay lighting, etc. All such variations are included within the scope of this disclosure.

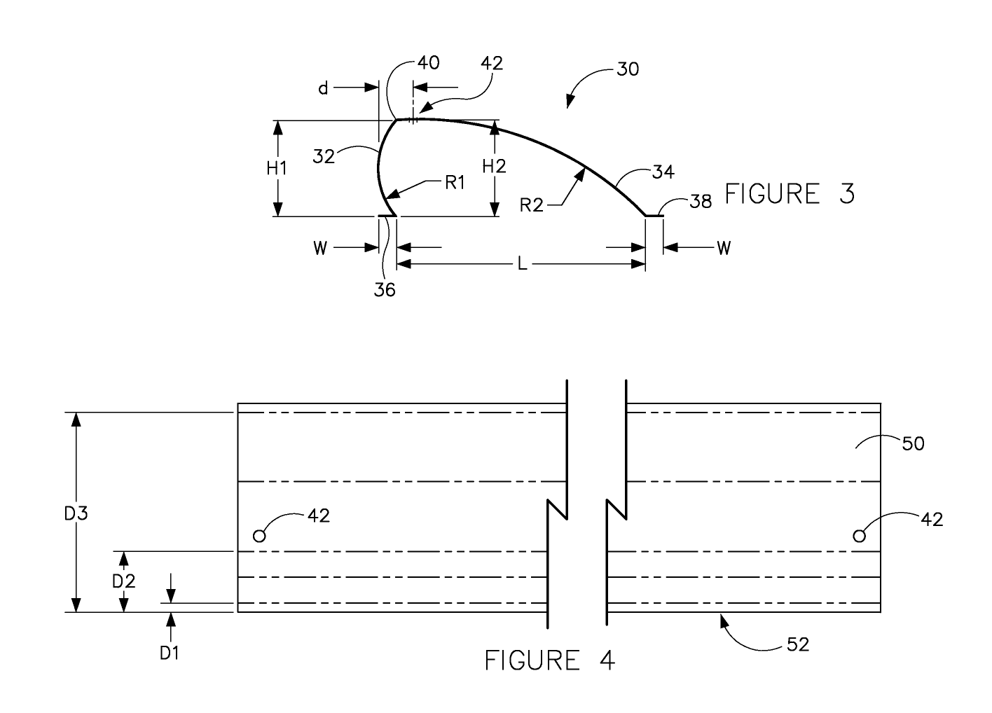

Referring to FIG. 3, the cross sectional geometric shape of reflector 30 is shown according to an exemplary embodiment. Reflector 30 is shown having an elongated member with a substantially constant cross sectional geometric shape, and a length that corresponds generally to the length of the light source(s) within the lighting device 10. The unique asymmetric geometric shape of reflector 30 includes the following components: a first curved segment 32, a second curved segment 34, a first flange 36, and a second flange 38. First curved segment 32 is separated from second curved segment 34 by an edge 40 (crease, ridge, etc). According to one embodiment where the light source is a T5 fluorescent light bulb, the components of the geometric shape have the following dimensions.

First curved segment 32 has a first inside radius R1 within the range of approximately 0.937-1.137 inches, and more particularly within the range of approximately 0.987-1.087 inches, and more particularly approximately 1.037 inches. First curved segment 32 has a first height H1 within the range of approximately 1.250-1.450 inches, and more particularly within the range of approximately 1.300-1.400 inches, and more particularly approximately 1.350 inches.

Second curved segment 34 has a second inside radius R2 within the range of approximately 4.304-4.504 inches, and more particularly within the range of approximately 4.354-4.454 inches, and more particularly approximately 4.404 inches. Second curved segment 34 has a second height dimension H2 of approximately 1.261-1.461 inches, and more particularly within the range of approximately 1.311-1.411 inches, and more particularly approximately 1.361 inches. At the high point of the second curved segment, a mounting aperture 42 may be provided for use in securing the reflector 30 to the body 12 of the lighting device 10 (e.g. by threaded fasteners or the like). According to one embodiment, the high point and the center of the aperture 42 are located at a distance “d” from the outermost edge of the first curved segment 32, where d is within the range of approximately 0.390-0.590 inches, and more particularly within the range of approximately 0.440-0.540 inches, and more particularly approximately 0.490 inches.

The first flange 36 and the second flange 38 are substantially coplanar and are formed with a width dimension W within the range of approximately 0.150-0.350 inches, and more particularly within the range of approximately 0.200-0.300 inches, and more particularly approximately 0.250 inches. The length L between the inner edges of each of flanges 36 and 38 defines the opening of the reflector 30. Length L is within the range of approximately 3.400-3.600 inches, and more particularly within the range of approximately 3.450-3.550 inches, and more particularly approximately 3.500 inches.

According to one embodiment, reflector 30 is custom formed into its unique asymmetric geometric shape from a sheet of material 50. Sheet of material 50 may have reflective properties (e.g. a material with a polished or otherwise reflective surface), or have a reflective material, such as a coating, appliqué, etc. applied thereto. The reflective surface of the reflector may be smooth, or may be formed with a textured pattern (e.g. hammer-tone, pebbled, etc.). According to one embodiment, reflector 30 is formed from a reflective metallic material, such as a reflective material marketed by Alanod under the trademark Miro, or the like, and has a thickness within the range of approximately 0.006-0.026 inches, and more particularly within the range of approximately 0.011-0.021 inches, and more particularly approximately 0.016 inches. According to other embodiments, a reflective coating may be applied over a non-reflective base material of the reflector, where the coating may be a coating such as a reflective powder coating such as the coatings described in U.S. Patent Application No. 61/165,397, the disclosure of which is hereby incorporated by reference in its entirety.

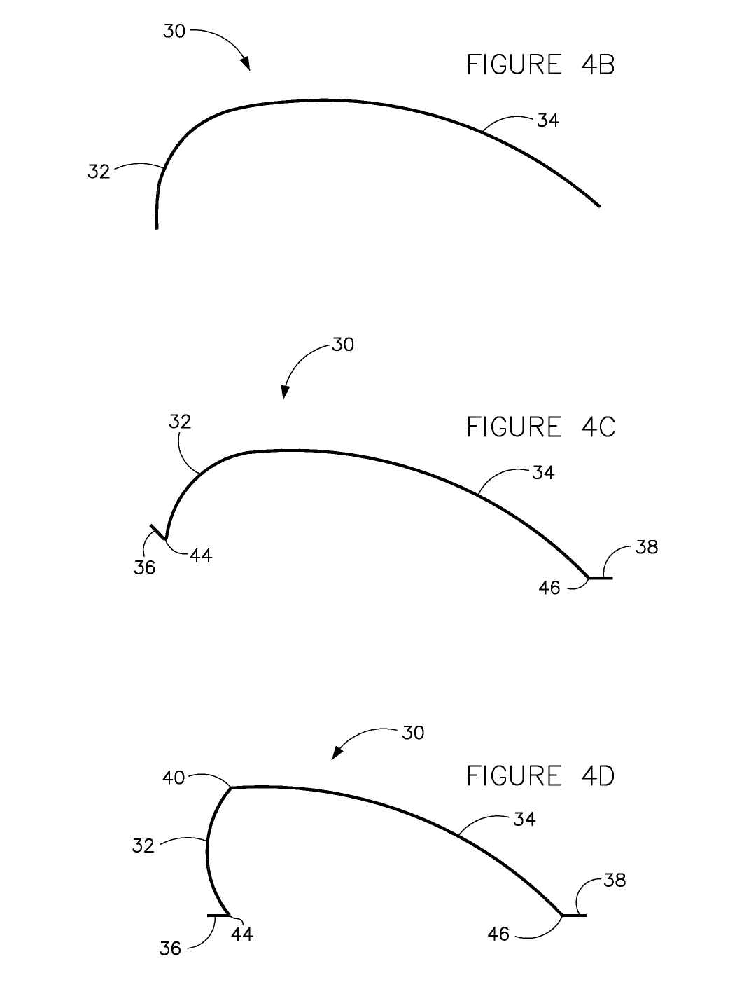

Referring to FIGS. 4A-4D, a method for making an elongated reflector having an asymmetric reflecting geometry for use in a throw forward lighting device is shown according to an exemplary embodiment. The method includes the step of providing a substantially rectangular sheet of material having a length corresponding generally to the length of the light source (e.g. approximately 20 inches or 44 inches, etc.) and having a width (according to one embodiment) of approximately 5.783 inches. The next step involves forming a compound radius corresponding to the first inside radius R1 of the first curved segment and the second inside radius R2 of the second curved segment using a suitable sheet metal forming device (e.g. a slip roller, etc.). With reference to a first leading side 52 shown in FIG. 4A, the first radius R1 is formed beginning at a distance D1 of approximately 0.214 inches until a distance D2 of approximately 1.659 inches. The second radius R2 is then formed beginning at distance D2 until a distance D3 of approximately 5.537 inches to form the compound radius shown in FIG. 4B. The next step involves forming the first and second flanges using a suitable sheet metal forming device (e.g. a press brake, etc.) to provide folds 44, 46 (e.g. crease, etc) as shown in FIG. 4B. The next step involves forming an edge between the first and second curved segments using a suitable sheet metal forming device (e.g. a press brake, etc.) at distance D2, as shown in FIG. 4C. Although specific dimensions have been described with reference to the illustrated embodiment, other dimensions that are suitable for use with similarly shaped geometries of larger or smaller scale may be used and are included within the scope of this disclosure.

According to an alternative embodiment, the reflectors may be formed from any suitable process (e.g. roll forming, etc.) and the reflectors may be made from a non-metallic base material (e.g. plastic, etc.) in a suitable forming operation (e.g. extrusion, blow molding, vacuum forming, etc) having the unique asymmetric cross sectional geometric shape, and then coated with a suitable reflective coating (e.g. powder coating, etc.).

Once formed, the reflector(s) may be assembled or installed within the lighting device at appropriate locations corresponding to the location of the light sources. Alternatively, the reflectors can be installed in existing lighting devices as retrofit kits to convert a conventional lighting device into a throw forward lighting device by replacing the conventional, symmetric reflector(s).

According to any exemplary embodiment, a lighting device is provided having a generally planar profile that may be installed in a generally horizontal configuration, and includes an elongated reflector having an asymmetric geometry configured to throw (e.g. cast, project, etc.) light forward (i.e. at an angle that is non-perpendicular to the plane of the lighting device) to permit illumination of lateral areas without having to tip-up (e.g. angle, incline, etc.) the lighting device or having to install a lighting device directly over the lateral area. The elongated reflector having the unique asymmetric cross sectional geometric shape is intended to provide more versatility in designing and constructing lighting or illumination systems in a manner that permits a planar fixture to remain in a generally horizontal orientation, and avoids the increased wind loads associated with “tipping-up” conventional lighting devices, and that is also substantially “dark sky” compliant (for outdoor applications), and that fits the constraints of building structures when used for indoor applications.

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more”.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A lighting device with a throw forward reflector, comprising:
a lighting device body;
at least one light source coupled to the lighting device body;
an elongated reflector having an asymmetric cross sectional geometry coupled to the lighting device body and disposed at least partially about the light source to project light from the light source at an angle that is non-perpendicular to a plane of the lighting device body.

2. The device of claim 1 wherein the light source comprises an elongated fluorescent light bulb.

3. The device of claim 2 wherein the asymmetric cross sectional geometry comprises a single sheet of material formed with a compound radius.

4. The device of claim 3 wherein the compound radius comprises a first curved segment having a first radius and a second curved segment having a second radius that is greater than the first radius.

5. The device of claim 4 wherein the first curved segment and the second curved segment are separated by a crease formed therebetween that extends at least partially along the length of the reflector.

6. The device of claim 4 wherein the first radius is within the range of approximately 0.937-1.137 inches, and the second radius is within the range of approximately 4.304-4.504 inches.

7. The device of claim 6 wherein the first radius is within the range of approximately 0.987-1.087 inches and the second radius is within the range of approximately 4.354-4.454 inches.

8. The device of claim 7 wherein the first radius is approximately 1.037 inches and the second radius is approximately 4.404 inches.

9. The device of claim 4 wherein the reflector comprises a textured reflective surface.

10. The device of claim 4 wherein the reflector comprises a reflective coating applied to a base material.

11. The device of claim 4 further comprising a first flange extending from the first curved section and a second flange extending from the second curved section, wherein the first flange and the second flange are substantially coplanar with one another.

12. The device of claim 11 wherein the at least one light source comprises a plurality of light sources and the elongated reflector comprises a plurality individual reflectors, and wherein the first flange of one of the individual reflectors overlaps the second flange of another of the individual reflectors.

13. The device of claim 1 wherein the at least one light source comprises a plurality of elongated fluorescent bulbs, and the elongated reflector comprises a single reflector body having a plurality of asymmetric geometries for reflecting light from the plurality of light sources in a throw forward manner.

14. A throw forward reflector, comprising:
an elongated reflector body formed from a sheet of material and having an asymmetric cross sectional profile, the profile comprising a compound radius having a first curved segment defined by a first radius and a second curved segment defined by a second radius that is greater than the first radius, and a crease extending at least partially along the length of the reflector body and defining an interface between the first curved segment and the second curved segment.

15. The reflector of claim 14 wherein the sheet of material comprises a textured reflective surface.

16. The reflector of claim 14 wherein the reflector body further comprises a reflective coating applied to the sheet of material.

17. The reflector of claim 14 further comprising a first flange extending from the first curved section and a second flange extending from the second curved section, wherein the first flange and the second flange are substantially coplanar with one another.

18. The reflector of claim 14 wherein the reflector body comprises a single sheet of material having a plurality of substantially identical asymmetric geometries configured to reflect light from a plurality of light sources.
